(19) United States
(12) Patent Application Publication
(10) Pub. No.: US 2015/0338608 A1
(43) Pub. Date: Nov. 26, 2015

(54) IMAGING LENS AND IMAGING UNIT

(71) Applicant: Sony Corporation, Tokyo (JP)

(72) Inventor: Shoji TAKEI, Kanagawa (JP)

(21) Appl. No.: 14/410,888

(22) PCT Filed: Jul. 12, 2013
(86) PCT No.: PCT/JP2013/069159

§ 371 Date: Dec. 23, 2014

(30) Foreign Application Priority Data
Sep. 18, 2012 (JP) 2012-203904

(51) Int. Cl. G02B 13/00; H04N 5/225; H04N 5/235; G02B 9/60

(52) U.S. Cl. CPC G02B 13/0045; G02B 9/60; H04N 5/2258; H04N 5/2351

(57) ABSTRACT

It includes: a first lens having a convex shape on an object side and having positive refractive power; a second lens having a concave shape on an image plane side and having negative refractive power; a third lens having, in a paraxial region, one of a biconvex shape and a plano-convex shape that is provided with a convex surface facing toward the image plane side, the third lens having positive refractive power; a fourth lens having aspherical shapes on both surfaces thereof and having negative refractive power; and a fifth lens having aspherical shapes on both surfaces thereof, having a concave shape in a paraxial region on the image plane side, and having negative refractive power, the first to fifth lenses being arranged in order from the object side. The following conditional expressions are satisfied, where ν2 is an Abbe number of the second lens, and ν4 is an Abbe number of the fourth lens.

ν2<30 (1)

ν4<30 (2)

### TECHNICAL FIELD

The present disclosure relates to an imaging lens that has, for example, a performance having F-number from about 1.8 to about 2.0 and having a focal length of about 28 mm (converted in 35 mm film), and is suitable for a camera module for a portable information terminal, a portable phone terminal, etc. The present disclosure also relates to an imaging unit that uses such an imaging lens.

### BACKGROUND ART

A lens configuration having four or less lenses is known as a lens for a camera module suitable for a mobile information terminal, a mobile phone terminal, etc. However, in the lens configuration having four or less lenses, for example, it is difficult to achieve a bright and high resolution performance having F-number of about 2.0 or smaller. Accordingly, there has been proposed a lens having a five-lens configuration in order to achieve a brighter and higher resolution performance (see Patent Documents 1 to 3).

### PRIOR ART DOCUMENT

### Patent Document

Patent Document 1: Japanese Unexamined Patent Application Publication No. 2012-98737

Patent Document 2: Japanese Unexamined Patent Application Publication No. 2007-264180

Patent Document 3: Japanese Unexamined Patent Application Publication No. 2010-256608

### SUMMARY OF THE INVENTION

Patent Document 1 discloses a lens having a five-lens configuration provided with positive, negative, positive, positive, and negative refractive powers in order from an object side. The lens having the five-lens configuration provided with such a refractive power arrangement is allowed to distribute positive power into three lenses, and is of a type in which, in particular, manufacturing sensitivity of the first lens is suppressed relatively easily. On the other hand, the market demands for bright and high resolving power and reduction in height (reduction in an optical-axis direction). However, in the lens disclosed in Patent Document 1, improvement in on-axial chromatic aberration is desired because the lens has high resolving power to a high frequency band. Also, because the fourth lens is configured of a convex meniscus lens having a sharp curvature on an image side, it is difficult to reduce principal point distance and is difficult to reduce the height. Also, when it is intended to cause F-number to be brighter and to secure a peripheral light amount, an outer diameter, in particular, an effective diameter of the fifth lens is increased.

On the other hand, Patent Documents 2 and 3 each disclose a lens having a five-lens configuration in which the fourth lens is configured to have negative refractive power, and an arrangement is made to have positive, negative, positive, negative, and negative refractive powers in order from the object side. In the lens disclosed in each of Patent Documents 2 and 3, aberrations are favorably corrected. However, further improvement is desired in spherical aberration, field curvature, etc. in order to achieve bright F-number, a focal length of about 28 nm (converted in 35 mm film) that is a current main stream for a portable camera, and high resolution from the center of an image to the periphery thereof. Also, in particular, in the lens disclosed in Patent Document 2, the third lens has a convex shape that has a strong curvature on the image side. As a result, the principal point distance tends to increase, which is disadvantageous in reduction in height.

Accordingly, it is desirable to provide an imaging lens and an imaging unit that are compact and capable of achieving a bright and high resolution performance.

An imaging lens according to an embodiment of the present disclosure includes: a first lens having a convex shape on an object side and having positive refractive power; a second lens having a concave shape on an image plane side and having negative refractive power; a third lens having, in a paraxial region, one of a biconvex shape and a plano-convex shape that is provided with a convex surface facing toward the image plane side, the third lens having positive refractive power; a fourth lens having aspherical shapes on both surfaces thereof and having negative refractive power; and a fifth lens having aspherical shapes on both surfaces thereof, having a concave shape in a paraxial region on the image plane side, and having negative refractive power. The first to fifth lenses are arranged in order from the object side. The following conditional expressions are satisfied,

ν2<30 (1)

ν4<30 (2)

where ν2 is an Abbe number of the second lens, and ν4 is an Abbe number of the fourth lens.

An imaging unit according to an embodiment of the present disclosure includes an imaging lens, and an imaging device configured to output an imaging signal based on an optical image formed by the imaging lens. The imaging lens therein is configured of the above-described imaging lens according to an embodiment of the present disclosure.

In the imaging lens or the imaging unit according to an embodiment of the present disclosure, there is provided a lens configuration having five lenses that are arranged to have positive, negative, positive, negative, and negative refractive powers in order from the object side, and a configuration of each of the lenses is optimized.

According to the imaging lens or the imaging unit of an embodiment of the present disclosure, there is provided a lens configuration having five lenses that are arranged to have positive, negative, positive, negative, and negative refractive powers in order from the object side as a whole, and a configuration of each of the lenses is optimized. As a result, it is possible to achieve compactness, and a bright and high resolution performance.

### BRIEF DESCRIPTION OF THE DRAWINGS

FIG. 1 is a lens cross-sectional view that illustrates a first configuration example of an imaging lens according to an embodiment of the present disclosure, and corresponds to Numerical example 1.

FIG. 2 is a lens cross-sectional view that illustrates a second configuration example of the imaging lens, and corresponds to Numerical example 2.

FIG. 3 is a lens cross-sectional view that illustrates a third configuration example of the imaging lens, and corresponds to Numerical example 3.

FIG. 4 is a lens cross-sectional view that illustrates a fourth configuration example of the imaging lens, and corresponds to Numerical example 4.

FIG. 5 is a lens cross-sectional view that illustrates a fifth configuration example of the imaging lens, and corresponds to Numerical example 5.

FIG. 6 is a lens cross-sectional view that illustrates a sixth configuration example of the imaging lens, and corresponds to Numerical example 6.

FIG. 7 is a lens cross-sectional view that illustrates a seventh configuration example of the imaging lens, and corresponds to Numerical example 7.

FIG. 8 is a lens cross-sectional view that illustrates an eighth configuration example of the imaging lens, and corresponds to Numerical example 8.

FIG. 9 is an aberration diagram that illustrates spherical aberration, astigmatism, and distortion of an imaging lens corresponding to Numerical example 1.

FIG. 10 is an aberration diagram that illustrates spherical aberration, astigmatism, and distortion of an imaging lens corresponding to Numerical example 2.

FIG. 11 is an aberration diagram that illustrates spherical aberration, astigmatism, and distortion of an imaging lens corresponding to Numerical example 3.

FIG. 12 is an aberration diagram that illustrates spherical aberration, astigmatism, and distortion of an imaging lens corresponding to Numerical example 4.

FIG. 13 is an aberration diagram that illustrates spherical aberration, astigmatism, and distortion of an imaging lens corresponding to Numerical example 5.

FIG. 14 is an aberration diagram that illustrates spherical aberration, astigmatism, and distortion of an imaging lens corresponding to Numerical example 6.

FIG. 15 is an aberration diagram that illustrates spherical aberration, astigmatism, and distortion of an imaging lens corresponding to Numerical example 7.

FIG. 16 is an aberration diagram that illustrates spherical aberration, astigmatism, and distortion of an imaging lens corresponding to Numerical example 8.

FIG. 17 is a front view that illustrates a configuration example of an imaging unit.

FIG. 18 is a rear view that illustrates the configuration example of the imaging unit.

### MODES FOR CARRYING OUT THE INVENTION

Some embodiments of the present disclosure are described below in detail with reference to the drawings. Incidentally, the description is provided in the following order.

### 1. Basic Configuration of Lens

### 2. Functions and Effects

### 3. Example of Application to Imaging Unit

### 4. Numerical Examples of Lens

### 5. Other Embodiments

### 1. Basic Configuration of Lens

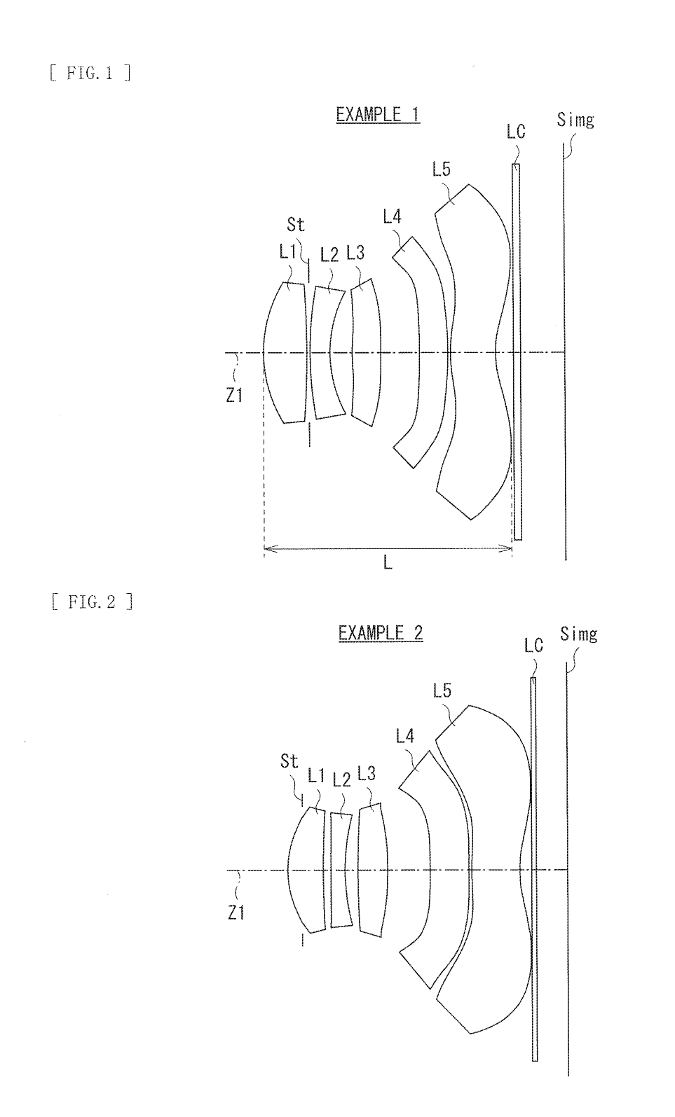

FIG. 1 illustrates a first configuration example of an imaging lens according to an embodiment of the present disclosure. The first configuration example corresponds to a lens configuration of Numerical example 1 described later. A basic configuration of the imaging lens according to the present embodiment is described referring to FIG. 1 where appropriate. In FIG. 1, a symbol Simg represents an image plane or an imaging device, and Z1 represents an optical axis.

The imaging lens according to the present embodiment is substantially configured of five lenses, in which a first lens L1, a second lens L2, a third lens L3, a fourth lens L4, and a five lens L5 are arranged along the optical axis Z1 in order from an object side.

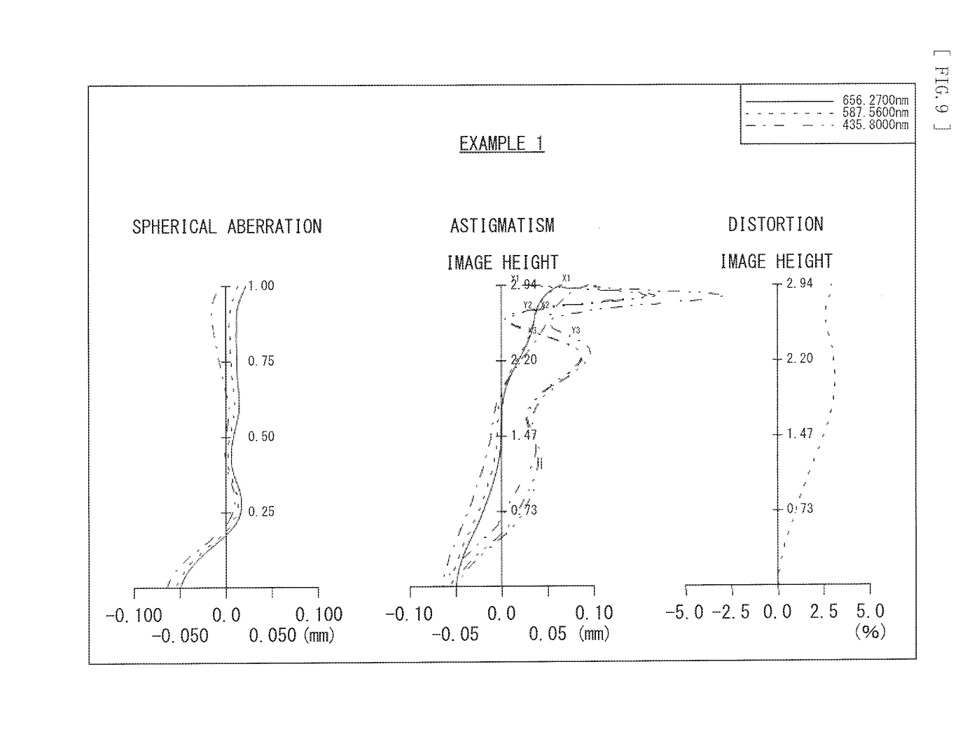

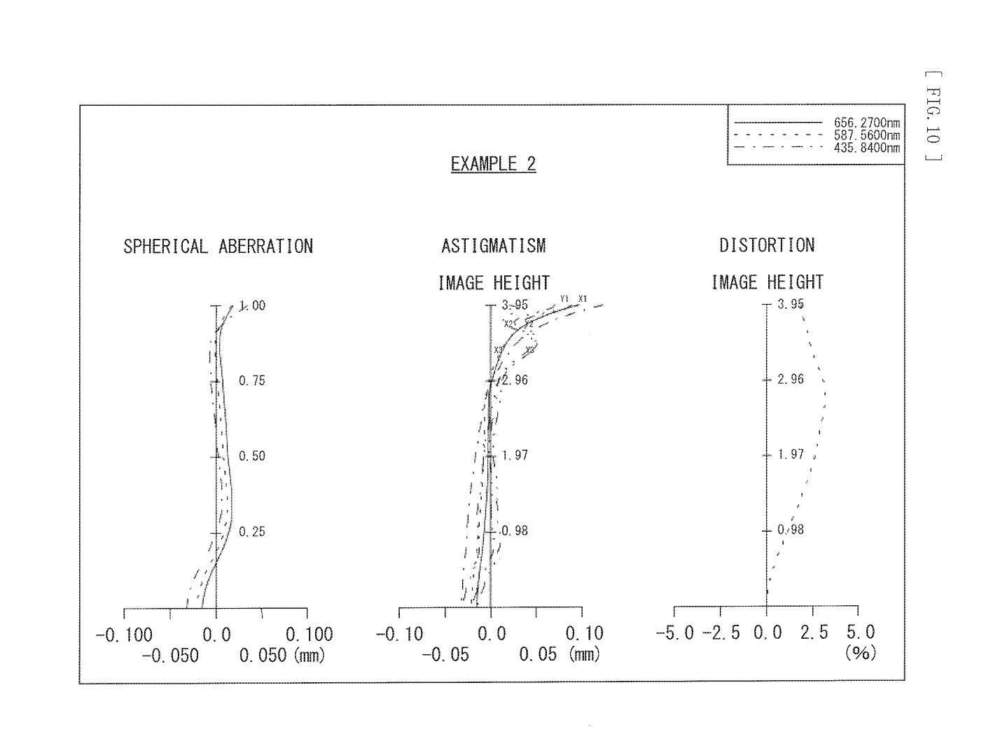

The first lens L1 has a convex shape on the object side and has positive refractive power. The second lens L2 has a concave shape on an image plane side and has negative refractive power. The third lens L3 has a biconvex shape in a paraxial region and has positive refractive power. Alternatively, the lens L3 may have, in the paraxial region, a plano-convex shape provided with a convex surface facing toward the image plane side, as in a configuration example illustrated in FIG. 8 described later. The fourth lens L4 has aspherical shapes on both surfaces thereof and has negative refractive power. The fifth lens L5 has aspherical shapes on both surfaces thereof, has a concave shape in a paraxial region on the image plane side, and has negative refractive power. Each of the both surfaces of the fifth lens L5 may preferably have an aspherical shape provided with an inflection point so that a concave-convex shape is varied in mid-course from a center portion thereof toward a peripheral portion thereof.

Other than the above, the imaging lens according to the present embodiment may preferably satisfy predetermined conditional expressions described later.

### 2. Functions and Effects

Next, functions and effects of the imaging lens according to the present embodiment are described.

As described above, in the lens having the configuration provided with five lenses that are arranged to have positive, negative, positive, positive, and negative refractive powers in order from the object side, an outer diameter, in particular, an effective diameter of the fifth lens L5 is increased when it is intended to cause F-number to be brighter and to secure a peripheral light amount. In the imaging lens according to the present embodiment, the fourth lens L4 is configured to have negative refractive power, and the lens is configured to have the five-lens configuration in which the lenses are arranged to have positive, negative, positive, negative, and negative refractive powers in order from the object side. As a result, it is made easier to secure the peripheral light amount while causing F-number to be brighter. Also, the effective diameter is reduced because the fourth lens L4 has negative refractive power, and it is possible to suppress increase in effective diameter of the fifth lens L5 accordingly. As a result, it may be possible to suppress degradation in accuracy in thickness caused by reduction in thickness of a lens barrel, for example.

In this imaging lens, by causing Conditional expression (2) described later to be satisfied, and configuring the fourth lens L4, for example, of a polycarbonate-based highly-refractive and highly-dispersive material, it is possible to favorably correct on-axial chromatic aberration and magnification chromatic aberration, and to maintain a high resolution performance from the center portion to the peripheral portion. Further, also by causing the second lens L2 to have negative refractive power, to satisfy Conditional expression (1) described later, and to be configured, for example, of a polycarbonate-based highly-refractive and highly-dispersive material, it is possible to achieve a similar effect.

Moreover, in this imaging lens, power distribution is performed so as not to cause each of the third lens L3 to the fifth lens L5 in particular to have a lens shape provided with a sharp curvature. Accordingly, this imaging lens is relatively advantageous in reduction in height thereof.

As described above, according to the present embodiment, the lens configuration provided with five lenses that are arranged to have positive, negative, positive, negative, and negative refractive powers in order from the object side is provided as a whole, and the configuration of the each of the lenses is optimized. Accordingly, it is possible to achieve compactness and a bright and high resolution performance. By providing a bright lens, shooting is allowed to be performed with high sensitivity when the lens is applied to an imaging unit. Also, by configuring all of the lenses of plastic lenses, it is possible to reduce cost.

(Description of Conditional Expressions)

In the imaging lens according to the present embodiment, it is possible to achieve a more favorable performance by optimizing the configuration of each of the lenses so that at least one of the following conditional expressions is satisfied, or preferably, two or more of the following conditional expressions are satisfied in combination.

ν2<30 (1)

ν4<30 (2)

ν2 is an Abbe number of the second lens L2, and ν4 is an Abbe number of the fourth lens L4.

Conditional expression (1) defines an appropriate value of the Abbe number ν2 of the second lens L2. Conditional expression (2) defines an appropriate value of the Abbe number ν4 of the fourth lens L4. When the value is over the upper limit in Conditional expression (1) or Conditional expression (2), on-axial chromatic aberration and magnification chromatic aberration are degraded. Also, a resolution performance for high frequency from the center portion to the peripheral portion is degraded.

1<f3/f<30 (3)

f3 is a focal length of the third lens L3, and f is a focal length of the whole system.

Conditional expression (3) defines an appropriate value of the focal length f3 of the third lens L3. When the value is smaller than the lower limit in Conditional expression (3), spherical aberration is degraded. Also, field curvature in a sagittal direction is degraded in an over direction, and the resolution performance in the peripheral portion tends to be lowered. When the value is over the upper limit in Conditional expression (3), on-axial chromatic aberration and magnification chromatic aberration are degraded. Also, the resolution performance for high frequency is lowered. Accordingly, it becomes difficult to cause F-number to be brighter.

−2.0<f2/f<−0.5 (4)

f2 is a focal length of the second lens L2.

Conditional expression (4) defines an appropriate value of the focal length f2 of the second lens L2. When the value is smaller than the lower limit in Conditional expression (4), on-axial chromatic aberration is degraded, and the resolution performance for high frequency around the center is lowered. When the value is over the upper limit in Conditional expression (4), spherical aberration is degraded, which makes it difficult to cause F-number to be brighter. Also, the field curvature in the tangential direction is degraded in the over direction, and the resolution performance in the peripheral portion tends to be lowered.

1.0<L/Ymax (5)

L is a distance in the optical-axis direction from an apex of the first lens L1 on the object side to a position, in a surface of the fifth lens L5 on the image side, that is protruded most toward the image side (see FIG. 1). Ymax is a maximum image height (a half value of a diagonal length of the imaging device to be used).

It is to be noted that, for example, in a case where the image-sided surface of the fifth lens L5 is an aspherical surface that has an inflection point at which the shape thereof varies from a concave shape to a convex shape as in the configuration example illustrated in FIG. 1, L is a distance in the optical-axis direction from the apex of the first lens L1 on the object side to the inflection point on the image-sided surface of the fifth lens L5.

When the value is smaller than the lower limit of Conditional expression (5), the power of the first lens L1 becomes excessively strong. This makes it difficult to correct spherical aberration, and makes it difficult to make F-number to be brighter accordingly.

### 3. Example of Application to Imaging Unit

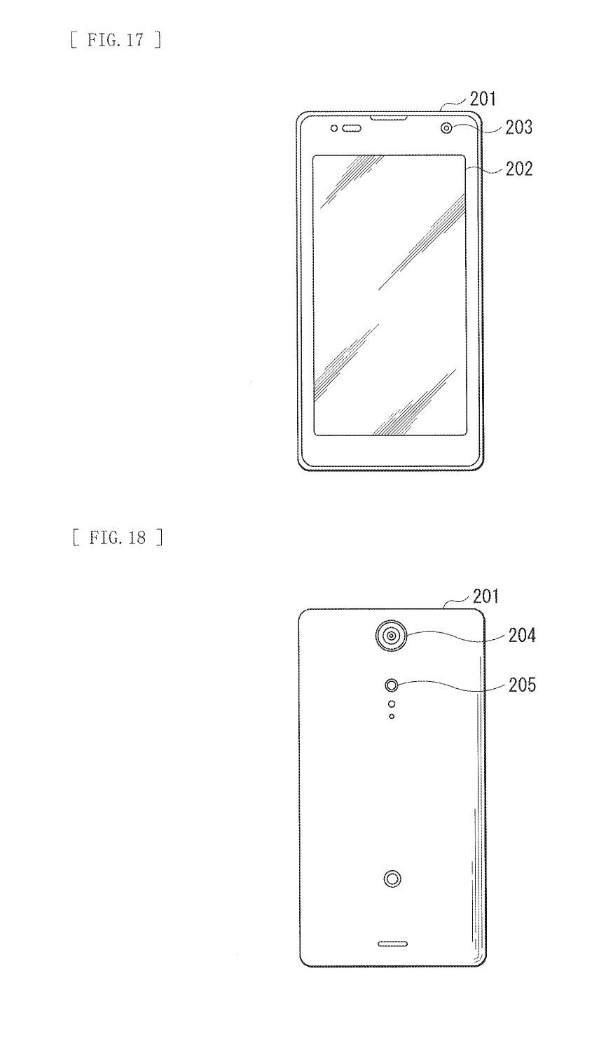

FIGS. 17 and 18 each illustrate a configuration example of an imaging unit to which the imaging lens according to the present embodiment is applied. The configuration example is an example of a portable terminal apparatus (such as a portable information terminal or a portable phone terminal) that includes the imaging unit. The portable terminal apparatus includes an almost-rectangular housing 201. A display section 202, a front camera section 203, etc. are provided on a front surface side (FIG. 17) of the housing 201. A main camera section 204, a camera flash 205, etc. are provided on a rear surface side (FIG. 18) of the housing 201.

The display section 202 may be, for example, a touch panel that allows various operations to be performed by sensing a state of contact to a surface thereof. Accordingly, the display section 202 has a function of displaying various pieces of information and an input function allowing various input operations by a user to be performed. The display section 202 displays an operation state, various data such as an image shot by the front camera section 203 or the main camera section 204, etc.

The imaging lens according to the present embodiment may be applicable, for example, as a lens for a camera module of the imaging unit (the front camera section 203 or the main camera section 204) in the portable terminal apparatus as that illustrated in FIGS. 17 and 18. When the imaging lens according to the present embodiment is used as a lens for a camera module, an imaging device such as CCD (Charge Coupled Devices) or a CMOS (Complementary Metal Oxide Semiconductor) is arranged near the image plane Simg of the imaging lens. Such an imaging device outputs an imaging signal (image signal) based on an optical image formed by the imaging lens. In this case, as illustrated in FIG. 1, an optical member LC such as a cover glass for protecting the imaging device or various optical filters may be arranged between the fifth lens L5 and the image plane Simg.

It is to be noted that the imaging lens according to the present embodiment is not limitedly applied to the above-described portable terminal apparatus, and may be applicable as an imaging lens for other electronic apparatus such as a digital still camera or a digital video camcorder.

### EXAMPLES

### 4. Numerical Examples of Lens

Next, specific numerical examples of the imaging lens according to the present embodiment are described.

(Configuration Common to Respective Numerical Examples)

Any of imaging lenses according to respective numerical examples below has a configuration that satisfies the basic configuration of the lens and the desirable conditions described above. Also, each of lens surfaces of the first lens L1 to the fifth lens L5 is configured of an aspherical surface.

In each of Examples, a shape of the aspherical surface is expressed by the following expression. In data showing aspherical surface coefficients, the symbol “E” indicates that a numerical value following the symbol “E” is “exponential expression” having 10 as a base, and a numerical value before “E” is multiplied by the numerical value represented by the exponential function having 10 as a base. To give an example, “1.0E-05” represents “1.0×10⁻⁵”.

Z=(Y²/R)/[1+{1−(1+K)(Y²/R²)}^{1/2}]+ΣAi·Yⁱ (Expression of Aspherical Surface)

Z is a sag amount of the aspherical surface, Y is a height from the optical axis, R is a paraxial curvature radius, K is a conic constant, and Ai is an i-th order (i is an integer of 3 or larger) aspherical surface coefficient.

### Numerical Example 1

Table 1 and Table 2 each show specific lens data corresponding to the imaging lens according to the first configuration example illustrated in FIG. 1. In particular, Table 1 shows basic lens data thereof, and Table 2 shows data related to the aspherical surfaces thereof.

In Tables 1 and 2, the surface numbers are attached so that the numbers are gradually increased toward the image side where a surface of a most-object-sided constituent element is set as the 1st surface. As the basic lens data in Table 1, there are shown a value of a paraxial curvature radius (mm) of each of the surfaces, a value of a spacing (mm) along the optical axis between adjacent surfaces, a value of a refractive index at a d-line (having a wavelength of 587.6 nm) of a material (medium) configuring the lens, and a value of an Abbe number thereof. A surface having a curvature radius shown as “INFINITY” is a planar surface.

It is to be noted that data is shown in similar forms also in tables for other numerical examples below.

In the first configuration example, an aperture stop St is provided between the first lens L1 and the second lens L2. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 1
Example 1

| Element | Surface | Curvature | | Refractive | Abbe |
|---|---|---|---|---|---|
| number | number | radius | Spacing | index (d) | number |
| L1 | 1 | 1.6137 | 0.665 | 1.5346 | 56 |
| | 2 | −18.0542 | 0.040 | | |
| | 3 (Stop) | — | 0.000 | | |
| L2 | 4 | 4.3833 | 0.300 | 1.6349 | 23.9 |
| | 5 | 1.6888 | 0.343 | | |
| L3 | 6 | 12.9943 | 0.425 | 1.5346 | 56 |
| | 7 | −11.9863 | 0.590 | | |
| L4 | 8 | −3.8484 | 0.419 | 1.6349 | 23.9 |
| | 9 | −4.0196 | 0.042 | | |
| L5 | 10 | 1.5919 | 0.680 | 1.5346 | 56 |
| | 11 | 1.1540 | 0.282 | | |
| LC | 12 | INFINITY | 0.1 | 1.5182 | 64.1 |
| | 13 | INFINITY | 0.66 | | |

TABLE 2
Example 1

| Surface | Aspherical surface coefficient | | | | |
|---|---|---|---|---|---|
| number | K | A4 | A6 | A8 | A10 |
| 1 | 2.47222E−01 | −6.25916E−02 | 3.74996E−01 | −2.00964E+00 | 6.28448E+00 |
| 2 | −6.26449E+00 | −2.25173E−01 | 1.06029E+00 | −2.78211E+00 | 4.45877E+00 |
| 3 (Stop) | — | — | — | — | — |
| 4 | 2.60547E−01 | −2.91764E−01 | 1.10222E+00 | −2.36324E+00 | 3.37487E+00 |
| 5 | −4.47479E−01 | −9.72557E−02 | −5.79956E−01 | 8.01160E+00 | −4.15829E+01 |
| 6 | −9.09080E+00 | −2.06470E−01 | 1.43581E+00 | −1.08758E+01 | 4.79735E+01 |
| 7 | −1.00000E+01 | −8.12683E−02 | 1.08035E−01 | −1.21873E+00 | 4.83326E+00 |
| 8 | 5.94639E+00 | 3.07525E−01 | −5.23762E−01 | 5.08743E−01 | −3.40642E−01 |
| 9 | 4.29159E+00 | 5.14697E−02 | −3.58215E−03 | 1.03872E−01 | −3.29508E−01 |
| 10 | −8.91789E+00 | −2.92548E−01 | 2.07556E−01 | −2.54817E−02 | −8.25590E−02 |
| 11 | −4.26117E+00 | −1.79818E−01 | 1.38092E−01 | −8.58361E−02 | 4.08260E−02 |
| | A12 | A14 | A16 | A18 | A20 |
| 1 | −1.26030E+01 | 1.61011E+01 | −1.26889E+01 | 5.61054E+00 | −1.06520E+00 |
| 2 | −4.37768E+00 | 2.36905E+00 | −5.40875E−01 | 0.00000E+00 | 0.00000E+00 |
| 3 (Stop) | — | — | — | — | — |
| 4 | −3.02831E+00 | 1.51450E+00 | −3.18543E−01 | 0.00000E+00 | 0.00000E+00 |
| 5 | 1.26312E+02 | −2.35415E+02 | 2.64644E+02 | −1.64680E+02 | 4.35765E+01 |
| 6 | −1.29065E+02 | 2.16307E+02 | −2.20359E+02 | 1.25047E+02 | −3.03207E+01 |
| 7 | −1.07353E+01 | 1.44135E+01 | −1.14924E+01 | 5.00231E+00 | −9.09311E−01 |
| 8 | 1.07921E−01 | −9.62970E−03 | 0.00000E+00 | 0.00000E+00 | 0.00000E+00 |
| 9 | 3.86615E−01 | −2.52935E−01 | 9.72070E−02 | −2.02023E−02 | 1.73627E−03 |
| 10 | 6.42259E−02 | −2.09850E−02 | 3.30257E−03 | −2.06039E−04 | 0.00000E+00 |
| 11 | −1.48298E−02 | 3.86073E−03 | −6.59714E−04 | 6.49919E−05 | −2.76192E−06 |

### Numerical Example 2

Table 3 and Table 4 each show specific lens data corresponding to the imaging lens according to the second configuration example illustrated in FIG. 2. In particular, Table 3 shows basic lens data thereof, and Table 4 shows data related to the aspherical surfaces thereof.

In the second configuration example, the aperture stop St is provided on the object side of the first lens L1. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 3
Example 2

| Element | Surface | Curvature | | Refractive | Abbe |
|---|---|---|---|---|---|
| number | number | radius | Spacing | index (d) | number |
| | 1 (Stop) | — | −0.3 | | |
| L1 | 2 | 1.9169 | 0.723 | 1.5346 | 56 |
| | 3 | 13.7127 | 0.145 | | |
| L2 | 4 | 9.3315 | 0.300 | 1.63493 | 23.9 |
| | 5 | 2.8752 | 0.260 | | |
| L3 | 6 | 5.9689 | 0.601 | 1.5346 | 56 |
| | 7 | −9.7910 | 0.873 | | |
| L4 | 8 | −8.8929 | 0.800 | 1.63493 | 23.9 |
| | 9 | −15.5394 | 0.047 | | |
| L5 | 10 | 4.3421 | 0.984 | 1.5346 | 56 |
| | 11 | 1.9634 | 0.235 | | |
| LC | 12 | INFINITY | 0.11 | 1.5182 | 64.1 |
| | 13 | INFINITY | 0.63 | | |

TABLE 4
Example 2

| Surface | Aspherical surface coefficient | | | | |
|---|---|---|---|---|---|
| number | K | A4 | A6 | A8 | A10 |
| 1 (Stop) | — | — | — | — | — |
| 2 | −1.00246E+00 | 1.41116E−02 | 2.26936E−02 | −4.46032E−02 | 6.57645E−02 |
| 3 | 1.00000E+01 | −5.80773E−02 | 1.21657E−01 | −1.55025E−01 | 1.72937E−01 |
| 4 | −1.00000E+01 | −1.72395E−01 | 3.06455E−01 | −3.77087E−01 | 3.75418E−01 |
| 5 | 4.66569E+00 | −1.89959E−01 | 1.89475E−01 | 3.03678E−02 | −7.15543E−01 |
| 6 | −6.02842E−01 | −8.72940E−02 | 5.29643E−02 | −6.78957E−02 | 3.79569E−02 |
| 7 | −1.00000E+01 | −2.98352E−02 | −6.71235E−02 | 2.04688E−01 | −4.11991E−01 |
| 8 | 9.65469E+00 | 1.97296E−02 | −6.21263E−02 | 3.10953E−02 | −1.45224E−02 |
| 9 | 1.00000E+01 | −2.50570E−02 | −2.17048E−03 | 3.07375E−03 | −2.29410E−03 |
| 10 | 0.00000E+00 | −1.74832E−01 | 5.71565E−02 | −1.10320E−02 | 1.14706E−03 |
| 11 | −1.08682E+00 | −1.23982E−01 | 4.40031E−02 | −1.22791E−02 | 2.30567E−03 |
| | A12 | A14 | A16 | A18 | A20 |
| 1 (Stop) | — | — | — | — | — |
| 2 | −5.25223E−02 | 2.24445E−02 | −3.85021E−03 | 0.00000E+00 | 0.00000E+00 |
| 3 | −1.43052E−01 | 7.04093E−02 | −1.54901E−02 | 0.00000E+00 | 0.00000E+00 |
| 4 | −2.89436E−01 | 1.38937E−01 | −3.05213E−02 | 0.00000E+00 | 0.00000E+00 |
| 5 | 1.61440E+00 | −1.96496E+00 | 1.37924E+00 | −5.16176E−01 | 7.76251E−02 |
| 6 | 1.15584E−01 | −2.66504E−01 | 2.46704E−01 | −1.04121E−01 | 1.61693E−02 |
| 7 | 5.26634E−01 | −4.16713E−01 | 2.00738E−01 | −5.36871E−02 | 6.32065E−03 |
| 8 | 2.09196E−03 | 0.00000E+00 | 0.00000E+00 | 0.00000E+00 | 0.00000E+00 |
| 9 | 5.88693E−04 | −4.66819E−05 | 0.00000E+00 | 0.00000E+00 | 0.00000E+00 |
| 10 | −3.98827E−05 | −6.45654E−07 | −5.52433E−08 | 0.00000E+00 | 0.00000E+00 |
| 11 | −2.67377E−04 | 1.69910E−05 | −4.53197E−07 | 0.00000E+00 | 0.00000E+00 |

### Numerical Example 3

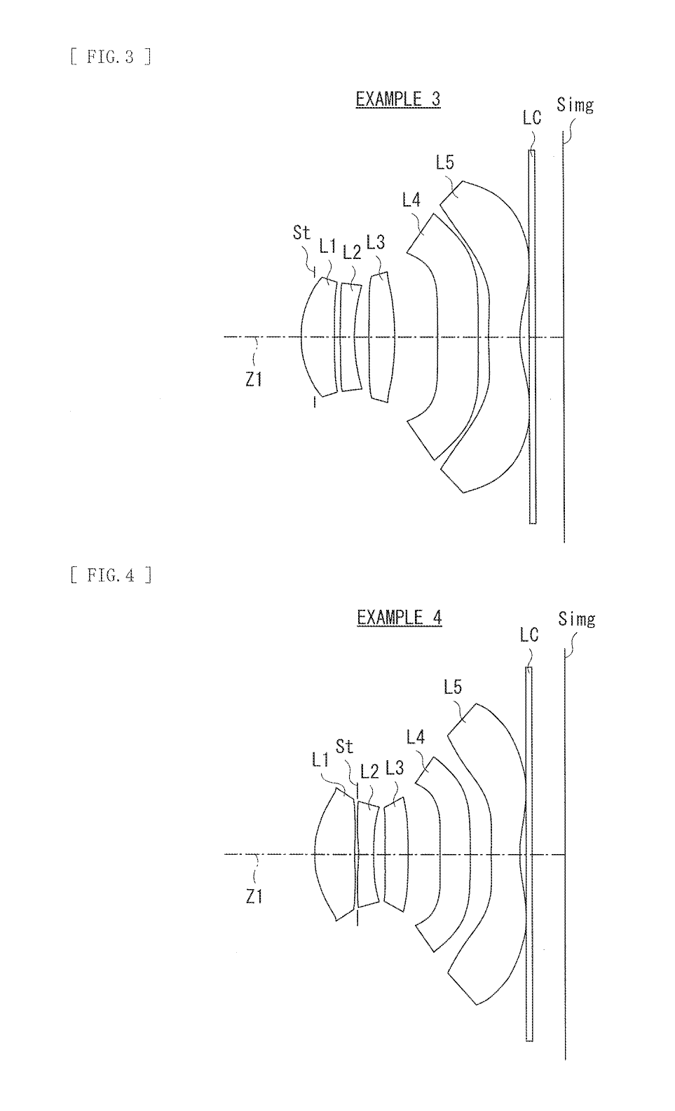

Table 5 and Table 6 each show specific lens data corresponding to the imaging lens according to the third configuration example illustrated in FIG. 3. In particular, Table 5 shows basic lens data thereof, and Table 6 shows data related to the aspherical surfaces thereof.

In the third configuration example, the aperture stop St is provided on the object side of the first lens L1. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 5
Example 3

| Element | Surface | Curvature | | Refractive | Abbe |
|---|---|---|---|---|---|
| number | number | radius | Spacing | index (d) | number |
| | 1 (Stop) | — | −0.3 | | |
| L1 | 2 | 1.9257 | 0.717 | 1.5346 | 56 |
| | 3 | 12.2475 | 0.131 | | |
| L2 | 4 | 8.3624 | 0.309 | 1.6349 | 23.9 |
| | 5 | 2.8686 | 0.327 | | |
| L3 | 6 | 7.6775 | 0.546 | 1.5346 | 56 |
| | 7 | −9.9762 | 0.963 | | |
| L4 | 8 | −432.2401 | 0.874 | 1.6349 | 23.9 |
| | 9 | −500.0000 | 0.212 | | |
| L5 | 10 | 3.5684 | 0.669 | 1.5346 | 56 |
| | 11 | 1.6561 | 0.218 | | |
| LC | 12 | INFINITY | 0.11 | 1.5182 | 64.1 |
| | 13 | INFINITY | 0.63 | | |

TABLE 6
Example 3

| Surface | Aspherical surface coefficient | | | | |
|---|---|---|---|---|---|
| number | K | A4 | A6 | A8 | A10 |
| 1 (Stop) | — | — | — | — | — |
| 2 | −9.17961E−01 | 1.70212E−02 | 4.84570E−03 | 5.01579E−03 | −9.83233E−03 |
| 3 | −1.00000E+01 | −4.79461E−02 | 1.11270E−01 | −1.38158E−01 | 1.54168E−01 |
| 4 | −7.58251E+00 | −1.28646E−01 | 2.22944E−01 | −2.50703E−01 | 2.36470E−01 |
| 5 | 4.89328E+00 | −1.35018E−01 | 1.43478E−01 | −7.13288E−02 | −1.28980E−01 |
| 6 | −1.67087E+00 | −6.23417E−02 | 7.88788E−03 | 6.28848E−02 | −2.08596E−01 |
| 7 | −1.00000E+01 | −4.42364E−02 | 1.62059E−03 | −2.42437E−02 | 8.41332E−02 |
| 8 | 1.00000E+01 | −5.47547E−03 | −2.91090E−02 | 1.07640E−02 | −4.66944E−03 |
| 9 | 1.00000E+01 | −2.07753E−02 | 4.21613E−03 | −4.21925E−03 | 1.37552E−03 |
| 10 | 6.56415E−01 | −2.00139E−01 | 6.90002E−02 | −1.82174E−02 | 3.87005E−03 |
| 11 | −4.99516E+00 | −8.70781E−02 | 3.38063E−02 | −1.03286E−02 | 2.08566E−03 |
| | A12 | A14 | A16 | A18 | A20 |
| 1 (Stop) | — | — | — | — | — |
| 2 | 1.40016E−02 | −8.69326E−03 | 2.33448E−03 | 0.00000E+00 | 0.00000E+00 |
| 3 | −1.21271E−01 | 5.57919E−02 | −1.08445E−02 | 0.00000E+00 | 0.00000E+00 |
| 4 | −1.79715E−01 | 8.62674E−02 | −1.91242E−02 | 0.00000E+00 | 0.00000E+00 |
| 5 | 2.86461E−01 | −2.24272E−01 | 2.14557E−02 | 6.58997E−02 | −2.86759E−02 |
| 6 | 3.95653E−01 | −4.43918E−01 | 3.00264E−01 | −1.09867E−01 | 1.64216E−02 |
| 7 | −1.53964E−01 | 1.72778E−01 | −1.12756E−01 | 3.98912E−02 | −5.79259E−03 |
| 8 | 5.27771E−04 | 0.00000E+00 | 0.00000E+00 | 0.00000E+00 | 0.00000E+00 |
| 9 | −2.91764E−04 | 4.03355E−05 | −2.36120E−06 | 0.00000E+00 | 0.00000E+00 |
| 10 | −6.07447E−04 | 5.73777E−05 | −2.33722E−06 | 0.00000E+00 | 0.00000E+00 |
| 11 | −2.53394E−04 | 1.65733E−05 | −4.52087E−07 | 0.00000E+00 | 0.00000E+00 |

### Numerical Example 4

Table 7 and Table 8 each show specific lens data corresponding to the imaging lens according to the fourth configuration example illustrated in FIG. 4. In particular, Table 7 shows basic lens data thereof, and Table 8 shows data related to the aspherical surfaces thereof.

In the fourth configuration example, the aperture stop St is provided between the first lens L1 and the second lens L2. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 7
Example 4

| Element | Surface | Curvature | | Refractive | Abbe |
|---|---|---|---|---|---|
| number | number | radius | Spacing | index (d) | number |
| L1 | 1 | 1.2570 | 0.644 | 1.5346 | 56 |
| | 2 | 11.2670 | 0.048 | | |
| | 3 (Stop) | — | 0.000 | | |
| L2 | 4 | −34.7694 | 0.250 | 1.6349 | 23.9 |
| | 5 | 4.4034 | 0.180 | | |
| L3 | 6 | 12.0119 | 0.368 | 1.5346 | 56 |
| | 7 | −15.6510 | 0.516 | | |
| L4 | 8 | −45.2985 | 0.476 | 1.6349 | 23.9 |
| | 9 | −59.8504 | 0.340 | | |
| L5 | 10 | 5.3014 | 0.450 | 1.5346 | 56 |
| | 11 | 1.4807 | 0.103 | | |
| LC | 12 | INFINITY | 0.1 | 1.5182 | 64.1 |
| | 13 | INFINITY | 0.4 | | |

TABLE 8
Example 4

| Surface | Aspherical surface coefficient | | | | |
|---|---|---|---|---|---|
| number | K | A4 | A6 | A8 | A10 |
| 1 | −1.33837E+00 | 6.36961E−02 | 5.92788E−02 | −6.37107E−01 | 3.34053E+00 |
| 2 | −1.00000E+01 | −3.00455E−01 | 4.39059E−01 | 1.60456E+00 | −1.36806E+01 |
| 3 (Stop) | — | — | — | — | — |
| 4 | −1.00000E+01 | −2.71646E−01 | 8.25078E−01 | 1.80136E+00 | −1.69668E+01 |
| 5 | 5.46890E+00 | −1.38621E−01 | 1.56138E+00 | −1.00466E+01 | 6.87586E+01 |
| 6 | −1.00000E+01 | −2.22765E−01 | −4.26183E−01 | 7.52617E+00 | −5.37647E+01 |
| 7 | 1.10000E+01 | −1.59643E−01 | −1.09742E−01 | 1.80227E+00 | −1.09163E+01 |
| 8 | −8.34409E−11 | −1.22842E−01 | −2.16453E−01 | 2.48444E−01 | −2.30366E−01 |
| 9 | −4.74049E−10 | −1.20598E−01 | −1.17708E−02 | −6.82492E−02 | 1.52065E−01 |
| 10 | 9.10389E−01 | −4.81617E−01 | 2.92929E−01 | −1.72984E−01 | 1.01070E−01 |
| 11 | −1.08366E+00 | −4.48811E−01 | 3.90630E−01 | −2.93363E−01 | 1.64092E−01 |
| | A12 | A14 | A16 | A18 | A20 |
| 1 | −1.06058E+01 | 1.98269E+01 | −2.20003E+01 | 1.31920E+01 | −3.27407E+00 |
| 2 | 4.78370E+01 | −1.01341E+02 | 1.32415E+02 | −9.78189E+01 | 3.11558E+01 |
| 3 (Stop) | — | — | — | — | — |
| 4 | 5.51510E+01 | −1.00315E+02 | 1.06765E+02 | −6.10765E+01 | 1.40574E+01 |
| 5 | −3.18530E+02 | 9.25524E+02 | −1.60338E+03 | 1.51037E+03 | −5.86918E+02 |
| 6 | 2.34683E+02 | −6.41665E+02 | 1.07275E+03 | −9.98888E+02 | 4.00260E+02 |
| 7 | 3.80481E+01 | −7.97072E+01 | 9.96993E+01 | −6.87020E+01 | 2.03218E+01 |
| 8 | 0.00000E+00 | 0.00000E+00 | 0.00000E+00 | 0.00000E+00 | 0.00000E+00 |
| 9 | −1.40573E−01 | 5.26244E−02 | −2.43304E−03 | −1.71116E−03 | 0.00000E+00 |
| 10 | −3.54697E−02 | 6.12480E−03 | −4.05860E−04 | 0.00000E+00 | 0.00000E+00 |
| 11 | −6.40799E−02 | 1.68909E−02 | −2.87015E−03 | 2.83825E−04 | −1.23915E−05 |

### Numerical Example 5

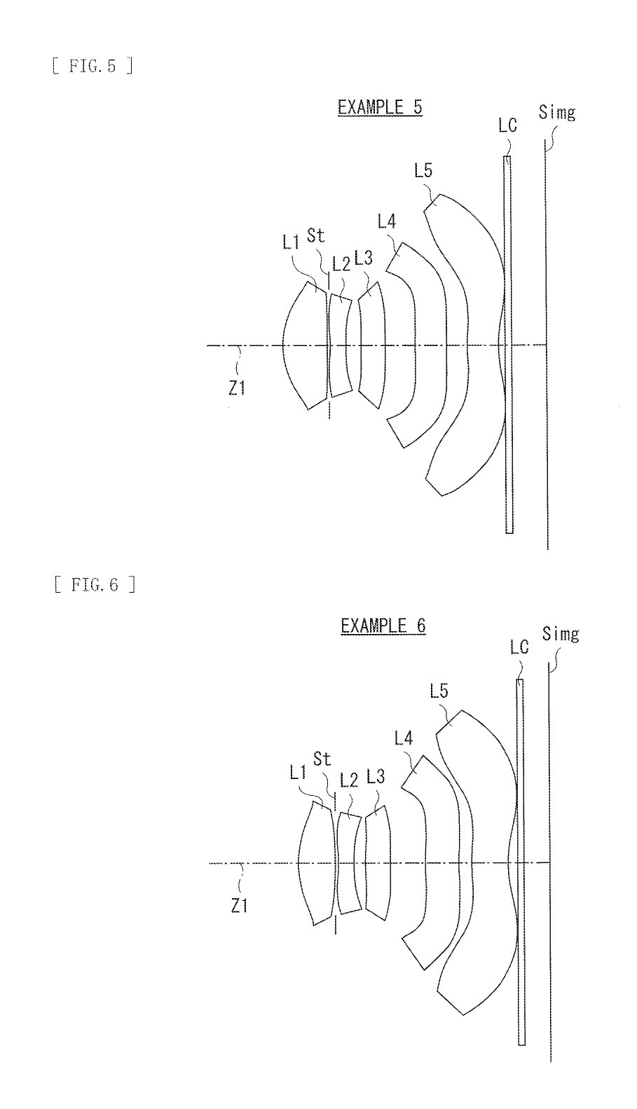

Table 9 and Table 10 each show specific lens data corresponding to the imaging lens according to the fifth configuration example illustrated in FIG. 5. In particular, Table 9 shows basic lens data thereof, and Table 10 shows data related to the aspherical surfaces thereof.

In the fifth configuration example, the aperture stop St is provided between the first lens L1 and the second lens L2. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 9
Example 5

| Element | Surface | Curvature | | Refractive | Abbe |
|---|---|---|---|---|---|
| number | number | radius | Spacing | index (d) | number |
| L1 | 1 | 1.2313 | 0.610 | 1.5346 | 56 |
| | 2 | 10.3493 | 0.049 | | |
| | 3 (Stop) | — | 0.000 | | |
| L2 | 4 | 136.3130 | 0.250 | 1.6349 | 23.9 |
| | 5 | 3.7561 | 0.196 | | |
| L3 | 6 | 10.2228 | 0.392 | 1.5346 | 56 |
| | 7 | −126.5118 | 0.471 | | |
| L4 | 8 | 8.8280 | 0.534 | 1.6349 | 23.9 |
| | 9 | 8.4604 | 0.241 | | |
| L5 | 10 | 4.4854 | 0.533 | 1.5346 | 56 |
| | 11 | 1.7381 | 0.109 | | |
| LC | 12 | INFINITY | 0.1 | 1.5182 | 64.1 |
| | 13 | INFINITY | 0.4 | | |

TABLE 10
Example 5

| Surface | Aspherical surface coefficient | | | | |
|---|---|---|---|---|---|
| number | K | A4 | A6 | A8 | A10 |
| 1 | −1.12342E+00 | 2.12745E−02 | 4.49582E−01 | −3.35395E+00 | 1.49446E+01 |
| 2 | −6.36886E+00 | −2.44811E−01 | 1.59674E−02 | 4.70738E+00 | −3.25303E+01 |
| 3 (Stop) | — | — | — | — | — |
| 4 | −1.00000E+01 | −2.23934E−01 | 9.85114E−01 | −1.23408E+00 | 6.36728E−01 |
| 5 | 1.00000E+01 | −2.87408E−01 | 7.47399E−01 | −4.16661E+00 | 1.48427E+01 |
| 6 | −1.00000E+01 | −1.51562E−01 | −1.71249E−01 | 1.24108E+00 | −4.39580E+00 |
| 7 | 1.00000E+01 | −8.26340E−02 | −1.22354E−01 | 9.00233E−02 | −8.44055E−02 |
| 8 | −4.98825E+00 | −7.76921E−02 | −5.74502E−03 | −2.06195E−02 | 3.04782E−02 |
| 9 | 1.27460E+00 | −3.59992E−01 | 1.40865E−02 | −1.99604E−02 | 6.23808E−04 |
| 10 | −9.76991E−01 | −2.71201E−01 | 1.22107E−01 | −3.37874E−02 | −5.58021E−03 |
| | A12 | A14 | A16 | A18 | A20 |
| 1 | −4.24226E+01 | 7.55248E+01 | −8.22413E+01 | 4.97461E+01 | −1.27630E+01 |
| 2 | 1.25285E+02 | −3.03208E+02 | 4.51169E+02 | −3.76017E+02 | 1.34194E+02 |
| 3 (Stop) | — | — | — | — | — |
| 4 | 5.10505E−01 | −4.39518E−01 | 0.00000E+00 | 0.00000E+00 | 0.00000E+00 |
| 5 | −3.02291E+01 | 3.10452E+01 | −1.14085E+01 | 0.00000E+00 | 0.00000E+00 |
| 6 | 8.43142E+00 | −8.10860E+00 | 2.28051E+00 | 1.79366E+00 | −1.04990E+00 |
| 7 | 0.00000E+00 | 0.00000E+00 | 0.00000E+00 | 0.00000E+00 | 0.00000E+00 |
| 8 | −2.46338E−02 | 8.70501E−03 | −7.15208−04 | −1.12111E−04 | 0.00000E+00 |
| 9 | 2.17865E−05 | 0.00000E+00 | 0.00000E+00 | 0.00000E+00 | 0.00000E+00 |
| 10 | 8.25113E−03 | −2.70172E−03 | 3.78867E−04 | −1.79564E−05 | −2.91780E−07 |

### Numerical Example 6

Table 11 and Table 12 each show specific lens data corresponding to the imaging lens according to the sixth configuration example illustrated in FIG. 6. In particular, Table 11 shows basic lens data thereof, and Table 12 shows data related to the aspherical surfaces thereof.

In the sixth configuration example, the aperture stop St is provided between the first lens L1 and the second lens L2. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 11
Example 6

| Element | Surface | Curvature | | Refractive | Abbe |
|---|---|---|---|---|---|
| number | number | radius | Spacing | index (d) | number |
| L1 | 1 | 1.3868 | 0.574 | 1.5346 | 56 |
| | 2 | −3.0649 | 0.040 | | |
| | 3 (Stop) | — | 0.000 | | |
| L2 | 4 | −4.8788 | 0.250 | 1.63493 | 23.9 |
| | 5 | 2.7387 | 0.183 | | |
| L3 | 6 | 8.0925 | 0.385 | 1.5346 | 56 |
| | 7 | −13.2777 | 0.542 | | |
| L4 | 8 | 20.4634 | 0.514 | 1.63493 | 23.9 |
| | 9 | 19.2863 | 0.202 | | |
| L5 | 10 | 3.8981 | 0.554 | 1.5346 | 56 |
| | 11 | 1.4883 | 0.142 | | |
| LC | 12 | INFINITY | 0.1 | 1.5182 | 64.1 |
| | 13 | INFINITY | 0.4 | | |

TABLE 12
Example 6

| Surface | Aspherical surface coefficient | | | | |
|---|---|---|---|---|---|
| number | K | A4 | A6 | A8 | A10 |
| 1 | −2.15171E+00 | 8.49457E−04 | 6.13096E−01 | −4.47242E+00 | 1.76302E+01 |
| 2 | −9.03776E+00 | 4.35748E−01 | −1.93848E+00 | 4.67700E+00 | −1.31740E+00 |
| 3 (Stop) | — | — | — | — | — |
| 4 | −1.00000E+01 | 5.92615E−01 | −2.05038E+00 | 6.76493E+00 | −1.33949E+01 |
| 5 | −1.03196E+00 | 1.55076E−01 | −3.48317E−01 | 1.47939E+00 | −1.76104E+00 |
| 6 | −1.00000E+01 | −2.32800E−01 | 7.53750E−01 | −5.84091E+00 | 2.50324E+01 |
| 7 | −1.00000E+01 | −9.99386E−02 | −4.60647E−01 | 2.81594E+00 | −9.79552E+00 |
| 8 | 1.00000E+01 | −2.46141E−02 | −2.21392E−01 | 1.85866E−01 | −1.33543E−01 |
| 9 | −4.98825E+00 | −1.55034E−02 | −7.97312E−02 | 2.06893E−03 | 6.59686E−02 |
| 10 | 8.81408E−01 | −3.56390E−01 | 1.24910E−01 | −1.35982E−02 | 0.00000E+00 |
| 11 | −1.15497E+00 | −3.33039E−01 | 2.47683E−01 | −1.84034E−01 | 1.09917E−01 |
| 12 | −1.15497E+00 | −3.33039E−01 | 2.47683E−01 | −1.84034E−01 | −1.09917E−01 |
| | A12 | A14 | A16 | A18 | A20 |
| 1 | −4.49140E+01 | 7.24569E+01 | −7.19698E+01 | 4.02334E+01 | −9.68319E+00 |
| 2 | −3.20688E+01 | 1.06164E+02 | −1.60996E+02 | 1.22361E+02 | −3.74904E+01 |
| 3 (Stop) | — | — | — | — | — |
| 4 | 1.51091E+01 | −7.21279E+00 | 0.00000E+00 | 0.00000E+00 | 0.00000E+00 |
| 5 | 2.21822E−02 | 2.10054E+00 | 0.00000E+00 | 0.00000E+00 | 0.00000E+00 |
| 6 | −5.84435E+01 | 7.03028E+01 | −3.25624E+01 | 0.00000E+00 | 0.00000E+00 |
| 7 | 1.79878E+01 | −1.14869E+01 | −1.23569E+01 | 2.36696E+01 | −1.04093E+01 |
| 8 | 0.00000E+00 | 0.00000E+00 | 0.00000E+00 | 0.00000E+00 | 0.00000E+00 |
| 9 | −6.78869E−02 | 2.72089E−02 | −3.79611E−03 | 0.00000E+00 | 0.00000E+00 |
| 10 | 0.00000E+00 | 0.00000E+00 | 0.00000E+00 | 0.00000E+00 | 0.00000E+00 |
| 11 | −4.85333E−02 | 1.47901E−02 | −2.86139E−03 | 3.10439E−04 | −1.42369E−05 |
| 12 | −4.85333E−02 | 1.47901E−02 | −2.86139E−03 | 3.10439E−04 | −1.42369E−05 |

### Numerical Example 7

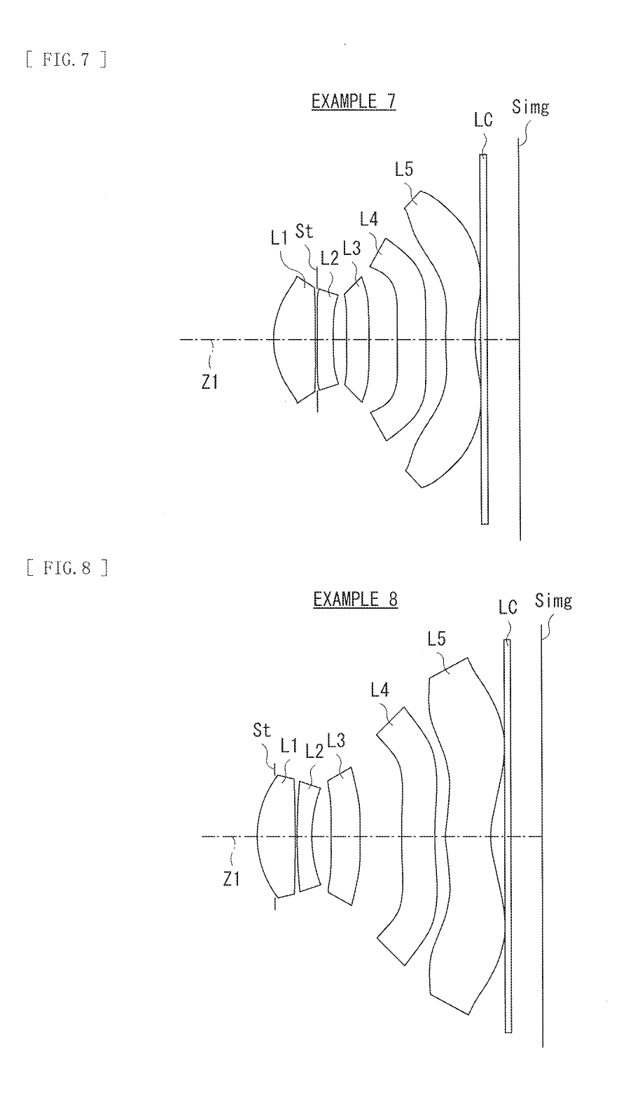

Table 13 and Table 14 each show specific lens data corresponding to the imaging lens according to the seventh configuration example illustrated in FIG. 7. In particular, Table 13 shows basic lens data thereof, and Table 14 shows data related to the aspherical surfaces thereof.

In the seventh configuration example, the aperture stop St is provided between the first lens L1 and the second lens L2. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 13
Example 7

| Element | Surface | Curvature | | Refractive | Abbe |
|---|---|---|---|---|---|
| number | number | radius | Spacing | index (d) | number |
| L1 | 1 | 1.1960 | 0.672 | 1.5346 | 56 |
| | 2 | 12.7862 | 0.042 | | |
| | 3 (Stop) | — | 0.000 | | |
| L2 | 4 | −21.4220 | 0.250 | 1.63493 | 23.9 |
| | 5 | 4.5827 | 0.225 | | |
| L3 | 6 | 59.2031 | 0.366 | 1.5346 | 56 |
| | 7 | −500.0000 | 0.458 | | |
| L4 | 8 | 12.1426 | 0.468 | 1.63493 | 23.9 |
| | 9 | 11.6558 | 0.324 | | |
| L5 | 10 | 4.7195 | 0.474 | 1.5346 | 56 |
| | 11 | 1.7819 | 0.096 | | |
| LC | 12 | INFINITY | 0.1 | 1.5182 | 64.1 |
| | 13 | INFINITY | 0.4 | | |

TABLE 14
Example 7

| Surface | Aspherical surface coefficient | | | | |
|---|---|---|---|---|---|
| number | K | A4 | A6 | A8 | A10 |
| 1 | −1.12626E+00 | 6.95053E−02 | 1.54239E−02 | −2.24159E−01 | 1.64774E+00 |
| 2 | −5.85012E+00 | −1.99659E−01 | 3.09727E−01 | −2.56187E−01 | 1.19748E+00 |
| 3 (Stop) | — | — | — | — | — |
| 4 | −1.00000E+01 | −1.05842E−01 | 5.46548E−01 | −4.78902E−01 | 3.19436E+00 |
| 5 | 9.54987E+00 | 1.45356E−02 | 1.16004E+00 | −9.24963E+00 | 6.76832E+01 |
| 6 | 1.00000E+01 | −1.76360E−01 | −6.99157E−01 | 7.95457E+00 | −4.72058E+01 |
| 7 | −1.00000E+01 | −1.92208E−01 | 3.99463E−01 | −2.85846E+00 | 1.34331E+01 |
| 8 | 1.00000E+01 | −1.25883E−01 | −1.23440E−01 | 1.17185E−01 | −1.22161E−01 |
| 9 | −4.98825E+00 | −1.00964E−01 | −7.58115E−02 | 1.72066E−01 | −2.72723E−01 |
| 10 | 1.09892E+00 | −3.49359E−01 | 1.27180E−01 | −1.56103E−02 | 2.90311E−04 |
| 11 | −9.18042E−01 | −3.07998E−01 | 2.07006E−01 | −1.53047E−01 | 9.24179E−02 |
| | A12 | A14 | A16 | A18 | A20 |
| 1 | −6.32601E+00 | 1.31005E+01 | −1.54257E+01 | 9.40961E+00 | 0.00000E+00 |
| 2 | −9.25344E+00 | 2.76570E+01 | −4.09497E+01 | 3.03626E+01 | −8.98247E+00 |
| 3 (Stop) | — | — | — | — | — |
| 4 | −2.50746E+01 | 8.82510E+01 | −1.59359E+02 | 1.47776E+02 | −5.58953E+01 |
| 5 | −3.16037E+02 | 9.17246E+02 | −1.57896E+03 | 1.46043E+03 | −5.40695E+02 |
| 6 | 1.57910E+02 | −2.86555E+02 | 2.20548E+02 | 4.00574E+01 | −1.09642E+02 |
| 7 | −3.97241E+01 | 7.32667E+01 | −8.13603E+01 | 4.95503E+01 | −1.26430E+01 |
| 8 | 0.00000E+00 | 0.00000E+00 | 0.00000E+00 | 0.00000E+00 | 0.00000E+00 |
| 9 | 2.66442E−01 | −1.60413E−01 | 5.28747E−02 | −7.07909E−03 | 0.00000E+00 |
| 10 | 2.69485E−06 | 0.00000E+00 | 0.00000E+00 | 0.00000E+00 | 0.00000E+00 |
| 11 | −4.00769E−02 | 1.19028E−02 | −2.28726E−03 | 2.53058E−04 | −1.20932E−05 |

### Numerical Example 8

Table 15 and Table 16 each show specific lens data corresponding to the imaging lens according to the eighth configuration example illustrated in FIG. 8. In particular, Table 15 shows basic lens data thereof, and Table 16 shows data related to the aspherical surfaces thereof.

In the eighth configuration example, the aperture stop St is provided on the object side of the first lens L1. The third lens L3 has, in a paraxial region, a plano-convex shape provided with a convex surface facing toward the image plane side. Also, each of the lenses of the first lens L1 to the fifth lens L5 is configured of a plastic lens. The optical member LC such as a cover glass for protecting the imaging device or various optical filters is provided between the fifth lens L5 and the image plane Simg.

TABLE 15
Example 8

| Element | Surface | Curvature | | Refractive | Abbe |
|---|---|---|---|---|---|
| number | number | radius | Spacing | index (d) | number |
| | 1 (Stop) | — | −0.350 | | |
| L1 | 2 | 1.8341 | 0.745 | 1.5346 | 56 |
| | 3 | −22.0051 | 0.046 | | |
| L2 | 4 | 20.2632 | 0.300 | 1.63493 | 23.9 |
| | 5 | 2.8225 | 0.383 | | |
| L3 | 6 | INFINITY | 0.592 | 1.5346 | 56 |
| | 7 | −9.7215 | 0.817 | | |
| L4 | 8 | 12.9714 | 0.671 | 1.6349 | 23.9 |
| | 9 | 6.5321 | 0.218 | | |
| L5 | 10 | 2.2089 | 0.899 | 1.5346 | 56 |
| | 11 | 1.7328 | 0.282 | | |
| LC | 12 | INFINITY | 0.11 | 1.5182 | 64.1 |
| | 13 | INFINITY | 0.63 | | |

TABLE 16
Example 8

| Surface | Aspherical surface coefficient | | | | |
|---|---|---|---|---|---|
| number | K | A4 | A6 | A8 | A10 |
| 1 (Stop) | — | — | — | — | — |
| 2 | −1.13555E+00 | 1.92280E−02 | 2.55085E−02 | −6.57034E−02 | 1.03422E−01 |
| 3 | −1.75864E+00 | 1.42292E−03 | 8.40920E−02 | −1.44595E−01 | 1.30903E−01 |
| 4 | 9.61111E+00 | −3.03886E−02 | 1.48449E−01 | −2.11566E−01 | 1.92815E−01 |
| 5 | 4.74118E+00 | −6.28419E−02 | 8.27674E−02 | −9.24385E−02 | 6.59685E−02 |
| 6 | 1.00000E+01 | −6.84510E−02 | 2.01436E−02 | −6.14872E−02 | 1.01919E−01 |
| 7 | 1.00000E+01 | −4.06081E−02 | −2.56727E−02 | 4.95991E−02 | −6.05009E−02 |
| 8 | −6.69138E+00 | −1.93080E−03 | −8.48739E−03 | −7.97649E−04 | −1.01773E−02 |
| 9 | −1.00000E+01 | −1.10340E−01 | 1.48089E−01 | −1.25346E−01 | 6.27652E−02 |
| 10 | −9.01890E+00 | −1.59480E−01 | 1.08449E−01 | −5.87085E−02 | 2.04662E−02 |
| 11 | −4.68200E+00 | −6.40985E−02 | 2.59291E−02 | −8.55825E−03 | 1.80000E−03 |
| | A12 | A14 | A16 | A18 | A20 |
| 1 (Stop) | — | — | — | — | — |
| 2 | −9.38970E−02 | 4.57422E−02 | −9.74619E−03 | 0.00000E+00 | 0.00000E+00 |
| 3 | −6.87301E−02 | 1.36930E−02 | 0.00000E+00 | 0.00000E+00 | 0.00000E+00 |
| 4 | −1.00549E−01 | 2.10310E−02 | 0.00000E+00 | 0.00000E+00 | 0.00000E+00 |
| 5 | −2.06486E−02 | 0.00000E+00 | 0.00000E+00 | 0.00000E+00 | 0.00000E+00 |
| 6 | −8.50140E−02 | 3.40701E−02 | 0.00000E+00 | 0.00000E+00 | 0.00000E+00 |
| 7 | 4.89746E−02 | −2.25865E−02 | 5.89211E−03 | −5.59069E−04 | 0.00000E+00 |
| 8 | 1.13851E−02 | −5.37066E−03 | 1.17904E−03 | −9.68963E−05 | 0.00000E+00 |
| 9 | −2.00922E−02 | 4.13725E−03 | −5.27590E−04 | 3.78653E−05 | −1.17037E−06 |
| 10 | −4.40274E−03 | 5389097E−04 | −4.80502E−05 | 2.19568E−06 | −4.32163E−08 |
| 11 | −2.34918E−04 | 1.90261E−05 | −9.49382E−07 | 2.83149E−08 | −4.20851E−10 |

[Other Numerical Value Data of Respective Numerical Examples]

Table 17 shows values related to the respective conditional expressions described above that are summarized for the respective numerical examples. Table 17 also shows values of a half angle of view ω, back focus fb, and F-number (Fno) for the respective numerical examples. As can be seen from Table 17, the values in the respective numerical examples for the respective conditional expressions are within the numerical ranges thereof.

TABLE 17

| | Example | Example | Example | Example | Example | Example | Example | Example |
|---|---|---|---|---|---|---|---|---|
| | 1 | 2 | 3 | 4 | 5 | 6 | 7 | 8 |
| ω | 36.9 | 39.3 | 38.8 | 38.9 | 40.2 | 40.5 | 38.7 | 38.7 |
| f | 3.759 | 4.824 | 4.929 | 3.552 | 3.343 | 3.289 | 3.552 | 4.784 |
| fb | 0.76 | 0.74 | 0.74 | 0.5 | 0.5 | 0.5 | 0.5 | 0.74 |
| Fno | 1.88 | 2.03 | 2.06 | 2.07 | 2.05 | 2.04 | 2.05 | 2.03 |
| Ymax | 2.934 | 3.94 | 3.94 | 2.934 | 2.934 | 2.934 | 2.934 | 3.94 |
| L | 3.79 | 4.97 | 4.96 | 3.38 | 3.38 | 2.79 | 3.38 | 4.95 |
| ν2 | 23.9 | 23.9 | 23.9 | 23.9 | 23.9 | 23.9 | 23.9 | 23.9 |
| ν4 | 23.9 | 23.9 | 23.9 | 23.9 | 23.9 | 23.9 | 23.9 | 23.9 |
| f3/f | 3.1 | 1.5 | 1.7 | 3.6 | 5.3 | 2.9 | 27.8 | 3.8 |
| f2/f | −1.2 | −1.4 | −1.4 | −1.7 | −1.8 | −0.8 | −1.7 | −1.1 |
| L/Ymax | 1.3 | 1.3 | 1.3 | 1.2 | 1.2 | 1.0 | 1.2 | 1.3 |

[Aberration Performance]

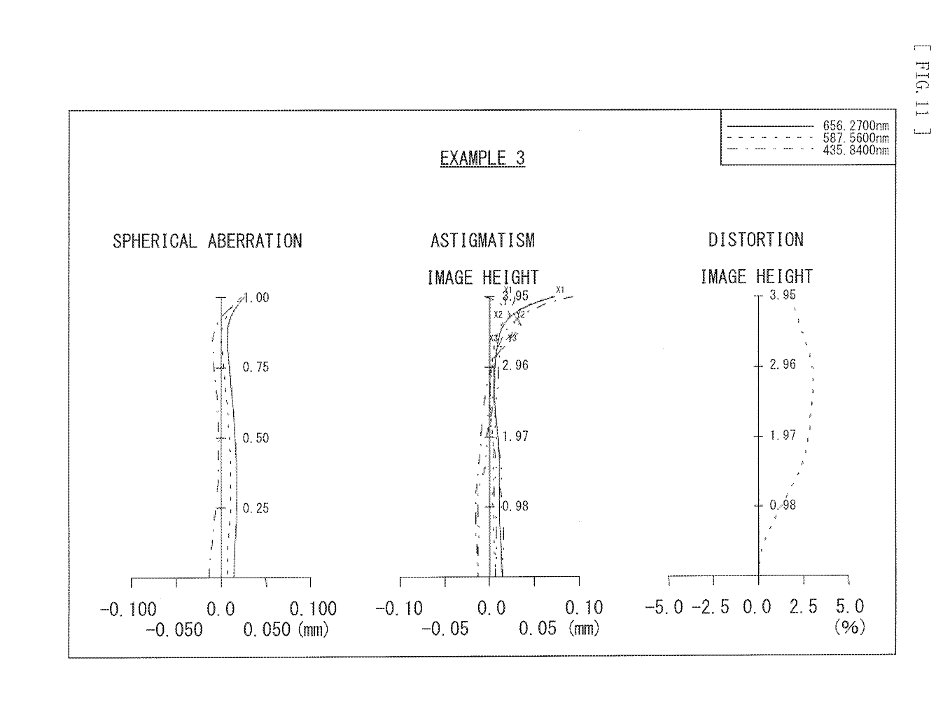

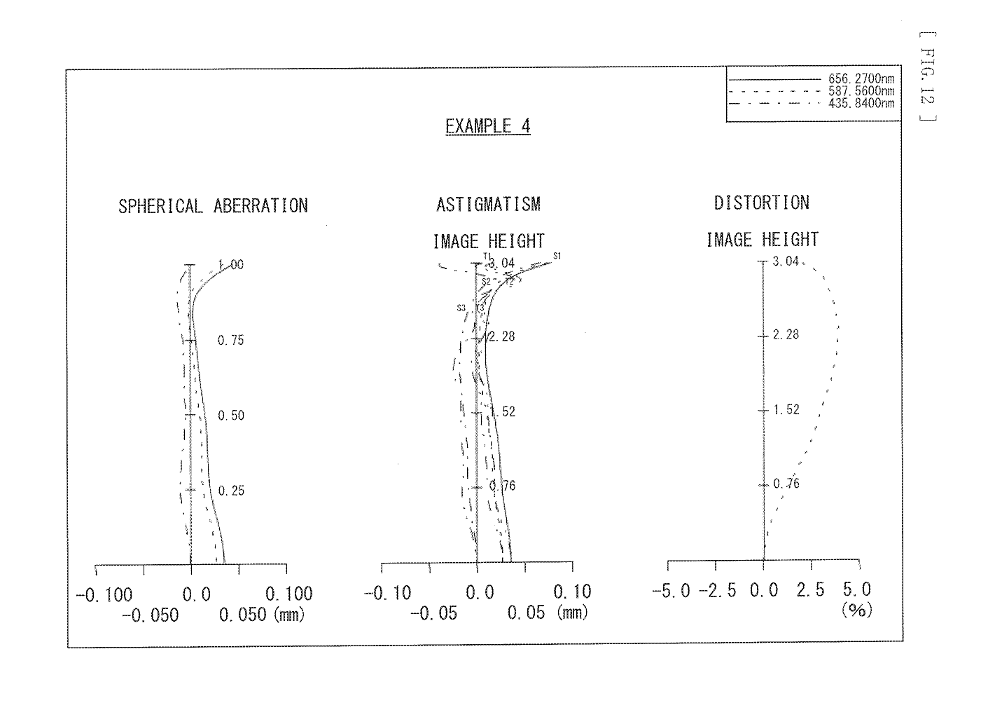

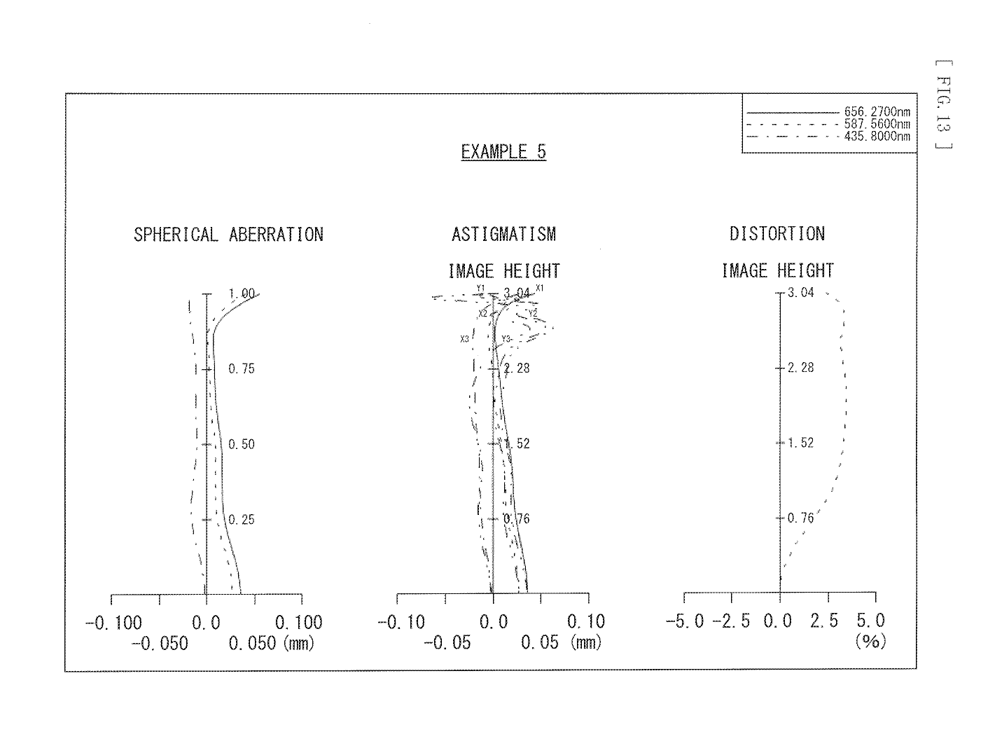

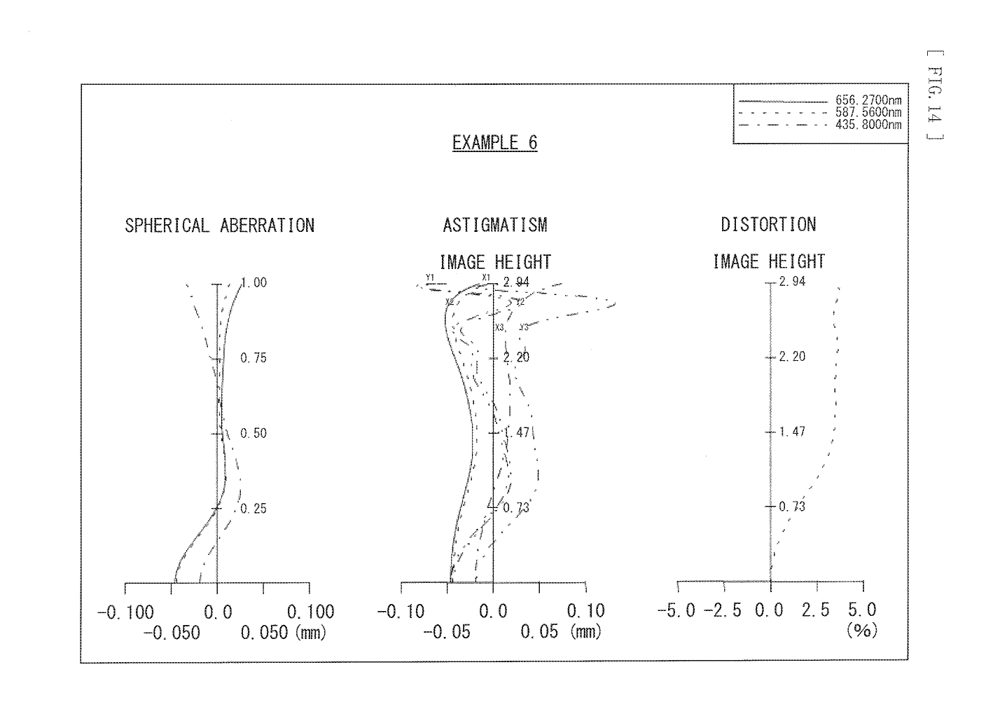

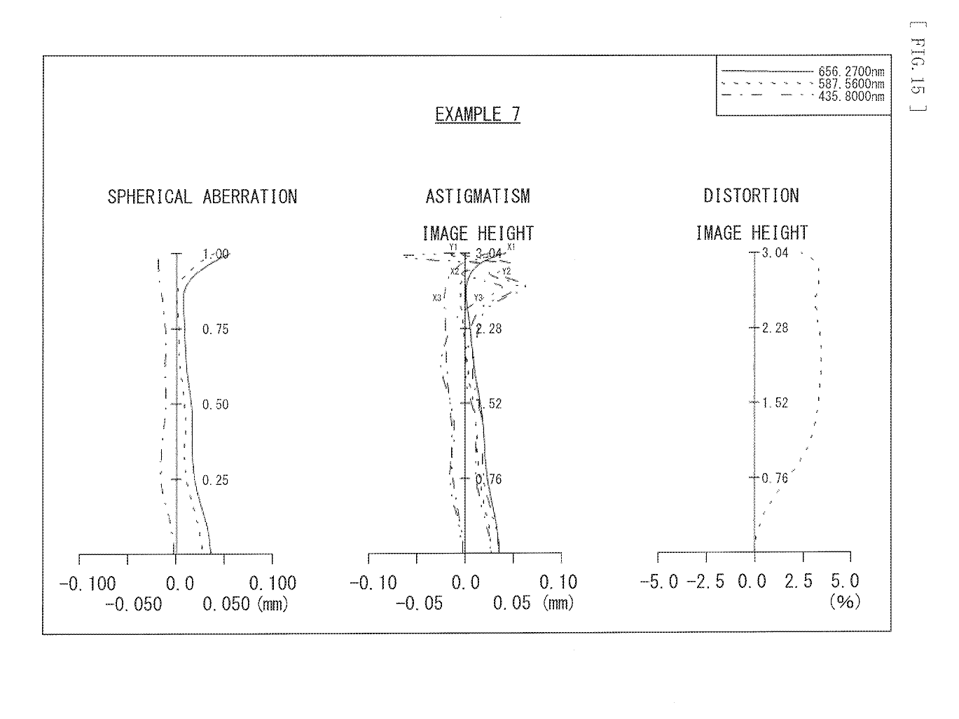

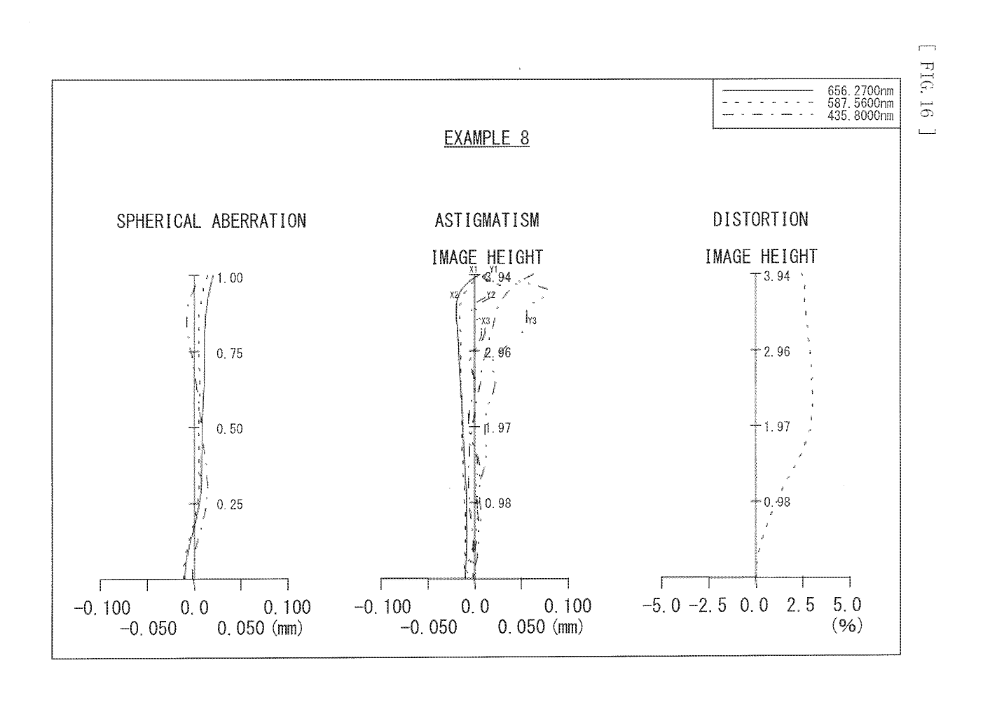

FIGS. 9 to 16 each illustrate an aberration performance of each of the numerical examples. Each of FIGS. 9 to 16 illustrates spherical aberration, astigmatism, and distortion as aberration diagrams. In the astigmatism diagram, X shows aberration in the sagittal direction and Y shows aberration in the meridional (tangential) direction.

As can be seen from the respective aberration diagrams described above, an imaging lens in which aberrations are favorably corrected is achieved in each of the Examples.

### 5. Other Embodiments

The technology of the present disclosure is not limited to the description of the embodiment and the Examples above, and various modifications may be made.

For example, the shape and the numerical value of each of the sections shown in each of the numerical examples described above are mere examples of embodying for carrying out the present technology, and the technical range of the present technology should not be construed limitedly on the basis thereof.

Moreover, in the embodiment and the Examples above, the configuration substantially including five lenses is described. However, there may be employed a configuration that further includes a lens substantially having no refractive power.

Moreover, the present technology may employ the following configurations, for example.

[1]

An imaging lens, including:

a first lens having a convex shape on an object side and having positive refractive power;

a second lens having a concave shape on an image plane side and having negative refractive power;

a third lens having, in a paraxial region, one of a biconvex shape and a plano-convex shape that is provided with a convex surface facing toward the image plane side, the third lens having positive refractive power;

a fourth lens having aspherical shapes on both surfaces thereof and having negative refractive power; and

a fifth lens having aspherical shapes on both surfaces thereof, having a concave shape in a paraxial region on the image plane side, and having negative refractive power,

the first to fifth lenses being arranged in order from the object side, wherein

the following conditional expressions are satisfied,

ν2<30 (1)

ν4<30 (2)

where ν2 is an Abbe number of the second lens, and

ν4 is an Abbe number of the fourth lens.

[2]

The imaging lens according to [1], wherein the following conditional expression is satisfied,

1<f3/f<30 (3)

where f3 is a focal length of the third lens, and

f is a focal length of a whole system.

[3]

The imaging lens according to [1] or [2], wherein the following conditional expression is satisfied,

−2.0<f2/f<−0.5 (4)

where f2 is a focal length of the second lens.

[4]

The imaging lens according to any one of [1] to [3], wherein the following conditional expression is satisfied,

1.0<L/Ymax (5)

where L is a distance in an optical-axis direction from an apex of the first lens on the object side to a position, in a surface of the fifth lens on an image side, that is protruded most toward the image side, and

Ymax is a maximum image height.

[5]

The imaging lens according to any one of [1] to [4], further including a lens substantially having no refractive power.

[6]

An imaging unit, including:

an imaging lens; and

an imaging device configured to output an imaging signal based on an optical image formed by the imaging lens,

the imaging lens including

a first lens having a convex shape on an object side and having positive refractive power,

a second lens having a concave shape on an image plane side and having negative refractive power,

a third lens having, in a paraxial region, one of a biconvex shape and a plano-convex shape that is provided with a convex surface facing toward the image plane side, the third lens having positive refractive power,

a fourth lens having aspherical shapes on both surfaces thereof and having negative refractive power, and

a fifth lens having aspherical shapes on both surfaces thereof, having a concave shape in a paraxial region on the image plane side, and having negative refractive power,

the first to fifth lenses being arranged in order from the object side, wherein

the following conditional expressions are satisfied,

ν2<30 (1)

ν4<30 (2)

where ν2 is an Abbe number of the second lens, and

ν4 is an Abbe number of the fourth lens.

[7]

The imaging unit according to [6], wherein the imaging lens further includes a lens substantially having no refractive power.

This application claims priority on the basis of Japanese Patent Application JP 2012-203904 filed Sep. 18, 2012, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. An imaging lens, comprising:
a first lens having a convex shape on an object side and having positive refractive power;
a second lens having a concave shape on an image plane side and having negative refractive power;
a third lens having, in a paraxial region, one of a biconvex shape and a plano-convex shape that is provided with a convex surface facing toward the image plane side, the third lens having positive refractive power;
a fourth lens having aspherical shapes on both surfaces thereof and having negative refractive power; and
a fifth lens having aspherical shapes on both surfaces thereof, having a concave shape in a paraxial region on the image plane side, and having negative refractive power,
the first to fifth lenses being arranged in order from the object side, wherein
the following conditional expressions are satisfied,
ν2<30 (1)
ν4<30 (2)
where ν2 is an Abbe number of the second lens, and
ν4 is an Abbe number of the fourth lens.

2. The imaging lens according to claim 1, wherein the following conditional expression is satisfied,
1<f3/f<30 (3)
where f3 is a focal length of the third lens, and
f is a focal length of a whole system.

3. The imaging lens according to claim 1, wherein the following conditional expression is satisfied,
−2.0<f2/f<−0.5 (4)
where f2 is a focal length of the second lens.

4. The imaging lens according to claim 1, wherein the following conditional expression is satisfied,
1.0<L/Ymax (5)
where L is a distance in an optical-axis direction from an apex of the first lens on the object side to a position, in a surface of the fifth lens on an image side, that is protruded most toward the image side, and
Ymax is a maximum image height.

5. An imaging unit, comprising:
an imaging lens; and
an imaging device configured to output an imaging signal based on an optical image formed by the imaging lens,
the imaging lens including
a first lens having a convex shape on an object side and having positive refractive power,
a second lens having a concave shape on an image plane side and having negative refractive power,
a third lens having, in a paraxial region, one of a biconvex shape and a plano-convex shape that is provided with a convex surface facing toward the image plane side, the third lens having positive refractive power,
a fourth lens having aspherical shapes on both surfaces thereof and having negative refractive power, and
a fifth lens having aspherical shapes on both surfaces thereof, having a concave shape in a paraxial region on the image plane side, and having negative refractive power,
the first to fifth lenses being arranged in order from the object side, wherein
the following conditional expressions are satisfied,
ν2<30 (1)
ν4<30 (2)
where ν2 is an Abbe number of the second lens, and
ν4 is an Abbe number of the fourth lens.
